(19) United States
(12) Patent Application Publication
(10) Pub. No.: US 2022/0137643 A1
(43) Pub. Date: May 5, 2022

(54) AIRCRAFT CONTROL METHOD AND AIRCRAFT

(71) Applicant: AUTEL ROBOTICS CO., LTD., Shenzhen (CN)

(72) Inventors: Tianbao ZHANG, Shenzhen (CN); Gang CHEN, Shenzhen (CN); Xianhong JIANG, Shenzhen (CN)

(21) Appl. No.: 17/573,882

(22) Filed: Jan. 12, 2022

Related U.S. Application Data
(63) Continuation of application No. PCT/CN2020/108954, filed on Aug. 13, 2020.

(51) Int. Cl. G05D 1/08; B64C 39/02; B64C 19/02; B64D 47/08; G05D 1/10; G05D 1/12

(52) U.S. Cl. CPC G05D 1/0816; B64C 39/024; B64C 19/02; B64D 47/08; G05D 1/101; B64C 2201/141; B64C 2201/027; B64C 2201/066; B64C 2201/108; B64C 2201/127; G05D 1/12

(57) ABSTRACT

Embodiments of the present invention relate to the field of aerial photography technologies and disclose an aircraft control method and an aircraft. The aircraft control method is applicable to the aircraft, and the aircraft includes a flight control system (FCS) configured to control the aircraft and a gimbal control system (GCS) configured to control a gimbal. The GCS can obtain a yaw control instruction to be inputted into the aircraft and attitude angle information outputted by the gimbal and then control yawing of the gimbal according to the yaw control instruction to be inputted into the aircraft and the attitude angle information outputted by the gimbal, so as to implement high-precision control of aerial photography of the aircraft, thereby ensuring high quality of an aerial video and resolving video freezing during aerial photography at a low rotation speed.

### CROSS-REFERENCE TO RELATED APPLICATIONS

The present application is a continuation of International Application No. PCT/CN2020/108954, filed on Aug. 13, 2020, which claims priority to Chinese patent application No. 2019106309153, filed on Jul. 12, 2019, which is incorporated herein by reference in its entirety.

### TECHNICAL FIELD

This application relates to the field of aerial photography technologies, and in particular, to an aircraft control method and an aircraft.

### BACKGROUND

With the development of flight technologies, aircrafts are widely used in various fields. For example, unmanned aerial vehicles (UAVs) have been widely used in three major fields of military, scientific research, and civilian, and specifically widely used in the fields such as power communications, meteorology, agriculture, marine, exploration, photography, search and rescue, disaster prevention and reduction, crop yield estimation, anti-drug and smuggling, border patrol, and security and anti-terrorism. As a new concept device in rapid development, the UAV has the advantages of a small size, a light weight, maneuverability, quick response, unmanned operation, and low operation requirements, and the UAV carries a plurality of types of photographing devices through a gimbal, to implement real-time image transmission and detection of high-risk areas, which is a powerful complement to satellite remote sensing and conventional aerial remote sensing.

An aerial-photography UAV includes a consumer-grade aerial-photography UAV and a professional aerial-photography UAV. The quality of aerial photography of both the consumer-grade aerial-photography UAV and the professional aerial-photography UAV depend on control effects of a body and a gimbal of the airplane. A flight control system (FCS) is the basic premise to ensure the stable flight of an unmanned aerial vehicle. A gimbal control system (GCS) is configured to improve the quality of an aerial video. High-frequency vibration of the body is isolated by using a vibration isolation system of the gimbal, and the control precision of the GCS is far higher than the control precision of the FCS. Generally, in the existing aerial-photography UAV, the GCS and the FCS are independent. That is, a pitch channel and a roll channel of the GCS do not respond to the change of an attitude of the FCS, and a first derivative of a yaw angle of the GCS converges to a yaw angle of the FCS.

During implementation of the present invention, the inventor finds at least the following problems in the related art: first, the FCS has no permission to control the GCS, and the gimbal only obtains a yaw angle/yaw angular velocity information of the airplane and has no feedback information for performing real-time interaction with the FCS. Secondly, a torque of yaw control of the FCS is small, channel coupling exists among yaw control, pitch control, and roll control. When external interference occurs, the rotation speed of a yaw channel of the FCS is nonuniform, resulting in an unsmooth aerial video. In particular, video freezing is serious at a low rotation speed. In addition, the control of a yaw channel of the gimbal is affected by the control of the yaw angle of the airplane, and the advantage of high-precision control of the GCS is not effectively utilized, resulting in an increase in control pressure of the FCS.

### SUMMARY

Embodiments of the present invention provide an aircraft control method and an aircraft, a characteristic of high-precision control of a gimbal control system (GCS) can be maximized, and video freezing during aerial photography at a low rotation speed in a yaw channel is resolved, thereby ensuring stability and fluency of the aerial video.

In the embodiments of the present invention, the following technical solutions are disclosed:

According to a first aspect, an embodiment of the present invention provides an aircraft control method, applicable to an aircraft, where the aircraft includes a flight control system (FCS) configured to control the aircraft and a GCS configured to control a gimbal, and the method includes:

obtaining, by the GCS, a yaw control instruction to be inputted into the aircraft and attitude angle information outputted by the gimbal; and

controlling, by the GCS, yawing of the gimbal according to the yaw control instruction to be inputted into the aircraft and the attitude angle information outputted by the gimbal.

In some embodiments, the obtaining, by the GCS, a yaw control instruction to be inputted into the aircraft and attitude angle information outputted by the gimbal includes:

obtaining, by the FCS, a speed instruction and a yaw instruction generated by the aircraft in a task flight mode;

obtaining, by the FCS, a rod magnitude of a remote control, where the remote control is communicatively connected to the aircraft;

generating, by the FCS, the yaw control instruction to be inputted into the aircraft according to the speed instruction and the yaw instruction generated by the aircraft in the task flight mode and the rod magnitude of the remote control; and

sending, by the FCS, the yaw control instruction to be inputted into the aircraft to the gimbal control system.

In some embodiments, the method further includes:

generating, by the FCS, a speed control instruction and a thrust instruction to be inputted into the aircraft according to the speed instruction and the yaw instruction generated by the aircraft in the task flight mode and the rod magnitude of the remote control.

In some embodiments, the method further includes:

obtaining, by the FCS, actual yaw information outputted by the gimbal;

obtaining, by the FCS, a speed and attitude angle information outputted by the aircraft; and

controlling, by the FCS, yawing of the aircraft according to the actual yaw information outputted by the gimbal, the speed outputted by the aircraft, the attitude angle information outputted by the aircraft, and the speed control instruction and the thrust instruction to be inputted into the aircraft.

In some embodiments, the obtaining, by the FCS, actual yaw information outputted by the gimbal includes:

obtaining, by the FCS, the actual yaw information outputted by the gimbal according to the attitude angle information outputted by the gimbal.

In some embodiments, the actual yaw information outputted by the gimbal includes an actual yaw angle and an actual yaw angular velocity of the gimbal.

In some embodiments, the attitude angle information outputted by the aircraft includes an actual attitude angle and an actual attitude angular velocity outputted by the aircraft.

In some embodiments, the attitude angle information outputted by the aircraft includes an actual attitude angle and an actual attitude angular velocity outputted by the aircraft.

According to a second aspect, an embodiment of the present invention provides an aircraft, including:

a body;

an arm, connected to the body;

a power apparatus, disposed on the arm and configured to provide power for the aircraft to fly;

a gimbal, disposed on the body;

an FCS, disposed on the body; and

a GCS, configured to control the gimbal and communicatively connected to the FCS, where

the gimbal control system is configured to:

obtain a yaw control instruction to be inputted into the aircraft and attitude angle information outputted by the gimbal; and

control yawing of the gimbal according to the yaw control instruction to be inputted into the aircraft and the attitude angle information outputted by the gimbal.

In some embodiments, the FCS is configured to:

obtain a speed instruction and a yaw instruction generated by the aircraft in a task flight mode;

obtain a rod magnitude of a remote control, where the remote control is communicatively connected to the aircraft;

generate the yaw control instruction to be inputted into the aircraft according to the speed instruction and the yaw instruction generated by the aircraft in the task flight mode and the rod magnitude of the remote control; and

send the yaw control instruction to be inputted into the aircraft to the gimbal control system.

In some embodiments, the FCS is further configured to:

generate a speed control instruction and a thrust instruction to be inputted into the aircraft according to the speed instruction and the yaw instruction generated by the aircraft in the task flight mode and the rod magnitude of the remote control.

In some embodiments, the FCS is further configured to:

obtain actual yaw information outputted by the gimbal;

obtain a speed and attitude angle information outputted by the aircraft; and

control yawing of the aircraft according to the actual yaw information outputted by the gimbal, the speed outputted by the aircraft, the attitude angle information outputted by the aircraft, and the speed control instruction and the thrust instruction to be inputted into the aircraft.

In some embodiments, the FCS is further configured to:

obtain the actual yaw information outputted by the gimbal according to the attitude angle information outputted by the gimbal.

In some embodiments, the actual yaw information outputted by the gimbal includes an actual yaw angle and an actual yaw angular velocity of the gimbal.

In some embodiments, the attitude angle information outputted by the aircraft includes an actual attitude angle and an actual attitude angular velocity outputted by the aircraft.

In some embodiments, the attitude angle information outputted by the gimbal includes an attitude angle and an attitude angular velocity of the gimbal.

According to a third aspect, an embodiment of the present invention provides a computer program product, including a computer program stored on a non-volatile computer-readable storage medium, the computer program including program instructions, the program instructions, when executed by a computer, causing the computer to perform the aircraft control method according to the first aspect.

According to a fourth aspect, an embodiment of the present invention provides a non-volatile computer-readable storage medium, storing computer-executable instructions, the computer-executable instructions being used to cause a computer to perform the aircraft control method according to the first aspect.

Embodiments of the present invention disclose an aircraft control method and an aircraft. The aircraft control method is applicable to the aircraft, and the aircraft includes an FCS configured to control the aircraft and a GCS configured to control a gimbal. The GCS can obtain a yaw control instruction to be inputted into the aircraft and attitude angle information outputted by the gimbal and then control yawing of the gimbal according to the yaw control instruction to be inputted into the aircraft and the attitude angle information outputted by the gimbal, so as to implement high-precision control of aerial photography of the aircraft, thereby ensuring high quality of an aerial video and resolving video freezing during aerial photography at a low rotation speed.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic diagram of an application environment of an aircraft control method according to an embodiment of the present invention.

FIG. 2 is a diagram of a specific structure of an aircraft in FIG. 1.

FIG. 3 is a flowchart of an aircraft control method according to an embodiment of the present invention.

FIG. 4 is a sub-flowchart of step 110 in the method shown in FIG. 3.

FIG. 5 is another sub-flowchart of step 110 in the method shown in FIG. 3.

FIG. 6 is a principle diagram of an aircraft control method according to an embodiment of the present invention.

FIG. 7 is a structural block diagram of an aircraft according to an embodiment of the present invention.

### DETAILED DESCRIPTION

The technical solutions in the embodiments of the present invention are described below in detail with reference to the accompanying drawings in the embodiments of the present invention. Apparently, the described embodiments are some rather than all of the embodiments of the present invention. All other embodiments obtained by a person of ordinary skill in the art based on the embodiments of the present invention without creative efforts shall fall within the protection scope of the present invention.

To make the objectives, technical solutions, and advantages of the present invention clearer, the following further describes the present invention in detail with reference to the accompanying drawings and the embodiments. It should be understood that the specific embodiments described herein are merely used to describe this application, instead of limiting the present invention.

It should be noted that, if no conflict occurs, features in the embodiments of the present invention may be combined with each other and fall within the protection scope of the present invention. In addition, although functional module division is performed in the schematic diagram of the apparatus/structure, and a logical sequence is shown in the flowchart, in some cases, the shown or described steps may be performed by using module division different from the module division in the apparatus, or in a sequence different from the sequence in the flowchart.

Unless otherwise defined, meanings of all technical and scientific terms used in this specification are the same as those generally understood by a person skilled in the technical field to which the present invention belongs. Terms used in the specification of the present invention are merely intended to describe objectives of the specific implementations, and are not intended to limit the present invention. A term “and/or” used in this specification includes any or all combinations of one or more related listed items.

In addition, technical features involved during implementations of the present invention that are described below may be combined with each other provided that no conflict occurs.

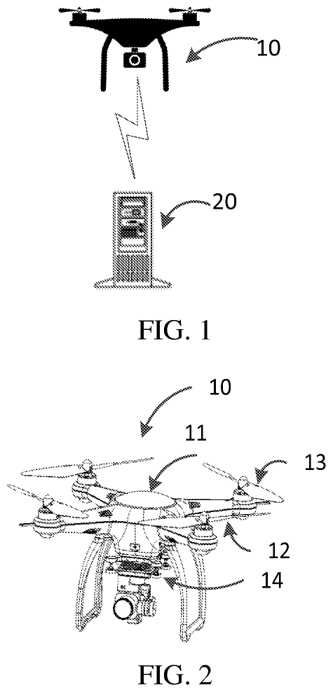

FIG. 1 is a schematic diagram of an application environment of an aircraft control method according to an embodiment of the present invention. FIG. 2 is a diagram of a specific structure of an aircraft 10 in FIG. 1. The aircraft control method of the present invention is applicable to an aircraft system. The aircraft system includes: an aircraft 10 and a remote control 20. The aircraft 10 is communicatively connected to the remote control 20. The aircraft 10 includes a body 11, an arm 12 connected to the body 11, a power apparatus 13 disposed on the arm 12, a gimbal 14 disposed on the body 11, and an FCS) and a GCS (not shown in the figure) disposed inside the body 11.

The remote control 20 may be in a wired or wireless connection with the aircraft 10. For example, communication is established through a wireless communication module, to implement data exchange between the remote control 20 and the aircraft 10.

The remote control 20 may be any appropriate remote control apparatus. The remote control 20 is a remote control unit on a ground (ship) surface or an aerial platform, and controls the aircraft 10 by sending a control instruction to the FCS. The remote control 20 is configured to transfer data, information, or an instruction. For example, after receiving data or information (for example, image information photographed by a photographing apparatus) sent by the aircraft 10, the remote control 20 may send the data or the information to a display device, to display flight information of the aircraft 10 on the display device and render or display the image information photographed by the aircraft 10.

The aircraft 10 may be any type of flight device, for example, an unmanned aerial vehicle (UAV), an unmanned spacecraft, or another movable device. The present invention is described below by using an example in which the UAV is the aircraft. It is obvious to a person skilled in the art that the use of another type of aircraft may not be limited. The UAV may be any type of UAV, for example, the UAV may be a small UAV. In some embodiments, the UAV may be a rotorcraft, for example, a multi-rotorcraft pushed by a plurality of pushing apparatuses through air. This is not limited in this embodiment of the present invention. Alternatively, the UAV may be another type of UAV or movable device, for example, a fixed-wing UAV, an unmanned airship, a para-wing UAV, or a flapping-wing UAV. In some embodiments, the aircraft 10 may rotate around one or more rotation axises. For example, the rotation axis may include a roll axis, a translation axis, and a pitch axis.

The body 11 may include a center frame and one or more arms 12 connected to the center frame. The one or more arms 12 extend from the center frame radially. In this embodiment of the present invention, there are four arms 12, one end of each arm 12 is connected to the center frame, and the other end is provided with the power apparatus 13. The gimbal 14 is mounted at the bottom of the body 11, and a camera is further mounted on the gimbal 14. In some other embodiments, for example, there may be two, four, or six arms 12. That is, a quantity of arms 12 is not limited thereto.

The power apparatus 13 is mounted on the arm 12, and one power apparatus 13 is usually disposed on one arm 12. In some cases, a plurality of power apparatuses 13 may alternatively be disposed on one arm 12, and the power apparatus 13 generally includes a motor and a propeller connected to an output shaft of the motor. The FCS may control the power apparatus 13. Specifically, a control instruction is sent to the FCS, and the FCS converts the control instruction to a corresponding pulse signal and outputs the pulse signal to the motor, to drive the power apparatus 13. The motor of the power apparatus 13 may be a brushless motor or may be a brushed motor. The one or more power apparatuses 13 provide power for the aircraft 10 to fly. The power enables the aircraft 10 to achieve one or more degrees of freedom movement, for example, front-back movement and up-down movement. A quantity of power apparatuses 13 is not limited either herein. In addition, in the aircraft 10 shown in FIG. 2, the power apparatus 13 is specifically four propellers, which are respectively disposed on the four arms 12. In some other embodiments, for example, there may be two, four, or six power apparatuses 13/propellers. That is, a quantity of power apparatuses 13/propellers is not limited herein.

The gimbal 14 is a photographing auxiliary device and is configured to carry a camera. A gimbal motor is also disposed on the gimbal 14. Specifically, a control instruction is sent to the GCS, and the GCS converts the control instruction to a corresponding pulse signal and outputs the pulse signal to the gimbal motor, to control movement (for example, a rotation speed) of the gimbal motor, so as to adjust an angle of photographing an image by the aircraft 10. The gimbal motor may be a brushless motor or may be a brushed motor. The gimbal 14 may be located at the top of the body 11 or may be located at the bottom of the body 11. The camera carried on the gimbal 14 may be a device for photographing an image, for example, a camera, a mobile phone, a video recorder, or a video camera. The camera may communicate with the FCS and perform photographing under the control of the FCS. For example, the FCS controls a photographing frequency of the camera for photographing an image, that is, a quantity of times of photographing per unit time. Alternatively, the FCS controls, by using the gimbal 14, an angle of the camera for photographing an image or the like. In addition, there may be a plurality of cameras, for example, one camera, two cameras, three cameras, or four cameras.

In addition, a sensing system may be further disposed on the body 11. The sensing system is connected to the FCS and the sensing system is configured to measure positions, status information, and the like of components of the aircraft 10, for example, a position, an angle, a speed, an acceleration, an angular velocity, and a flight height. For example, when the aircraft 10 performs flight, current flight information of the aircraft may be obtained in real time by using the sensing system, to determine a flight state of the aircraft in real time. The sensing system may include at least one of sensors such as an infrared sensor, an acoustic sensor, a gyroscope, an electronic compass, an inertial measurement unit (IMU), a visual sensor, a global navigation satellite system, and a barometer. For example, the global navigation satellite system may be a global positioning system (GPS). An attitude parameter of the UAV 100 during flight may be measured by using the IMU, a flight height of the aircraft 10 may be measured by using the infrared sensor or the acoustic sensor, and the like.

The gimbal 14 is controlled by the GCS. The GCS is communicatively connected to the FCS, to implement data exchange between the gimbal 14 and the FCS.

The FCS and the GCS (not shown in the figure) are execution subjects of the aircraft control method in the embodiments of the present invention. The FCS may be any appropriate chip capable of implementing the aircraft control method of the present invention, for example, a microprocessor, a micro control unit, a single-chip microcomputer, or a controller. Specifically, the FCS is at least a chip or an apparatus that can obtain data and an instruction, process the data and the instruction, and send the data and the instruction and has a computing function, and may be set according to an actual requirement.

The aircraft 10, as a flight vehicle, is mainly configured to complete a specific task through flight, for example, a flight task of flying to a specified place or a photographing task of performing photographing during flight. During aerial photography of the aircraft 10, generally, to enable a user to see a desirable image of a target region and obtain a better photographing effect, the aircraft 10 needs to control the power apparatus 13 and the gimbal 14, so that the aircraft 10 can move slightly in a plurality of directions of front, back, left, and right, to implement high-precision control of a flight direction and a flight distance of the aircraft 10. Alternatively, when there is wind, the aircraft 10 also needs to move slightly in a plurality of directions, to achieve an effect of stable photographing.

For example, when the aircraft 10 rotates around a yaw axis at a low speed in a hover state, or when the aircraft 10 rotates around a yaw axis at a low speed in a normal movement mode, or when the aircraft rotates around a yaw axis at a low speed in an extreme operation condition, or when the aircraft performs flight in a windy or no wind environment, it is necessary to ensure the uniformity of the rotation speed of a yaw channel of the gimbal 14 at a low rotation speed of a flight yaw channel, thereby ensuring high quality of an aerial image or video and resolving video freezing during aerial photography at the low rotation speed. Therefore, high-precision control needs to be performed on aerial photography, to improve the stability of aerial photography.

Based on the foregoing, in this embodiment of the present invention, the FCS obtains a speed control instruction to be inputted into the aircraft and actual yaw information outputted by the gimbal 14, and then controls yawing of the aircraft according to the speed control instruction to be inputted into the aircraft and the actual yaw information outputted by the gimbal 14, so that yawing of the aircraft keeps consistent with yawing of the gimbal 14.

In an embodiment of the present invention, the GCS first obtains a yaw control instruction to be inputted into the aircraft and attitude angle information outputted by the gimbal 14. The attitude angle information outputted by the gimbal 14 includes an actual attitude angle and an actual attitude angular velocity of the gimbal 14. The GCS outputs actual yaw information of the gimbal 14 according to the yaw control instruction to be inputted into the aircraft and the attitude angle information outputted by the gimbal 14 and sends the actual yaw information to the FCS. In an embodiment of the present invention, the actual yaw information includes an actual yaw angle and an actual yaw angular velocity of the gimbal 14.

In an embodiment of the present invention, the speed control instruction to be inputted into the aircraft and the yaw control instruction to be inputted into the aircraft are obtained by performing instruction fusion on a speed instruction and a yaw instruction generated by the aircraft in a task flight mode and a rod magnitude of the remote control 20.

In the embodiments of the present invention, a yaw control instruction to be inputted into an aircraft is first inputted into a GCS, and the GCS generates, according to the instruction, a yaw angle used by a gimbal motor PWM to adjust a gimbal, and then feeds back actual yaw information outputted by the gimbal to an FCS. The FCS generates a yaw angle and a yaw angular velocity of a motor PWM of a power apparatus 13 for controlling the aircraft according to the actual yaw information outputted by the gimbal and a speed control instruction to be inputted into the aircraft, so that the yaw angle and the yaw angular velocity of the aircraft keeps consistent with the yaw angle and the yaw angular velocity of the gimbal 14. The yaw control instruction obtained through instruction fusion is directly inputted into the GCS without being polluted by noise of the aircraft. Therefore, a change curve is very smooth, and the control precision of the GCS is high, thereby ensuring the stability of the aerial video without video freezing. However, in this case, the aircraft does not receive a yaw rotation instruction. To keep consistent with the yawing of the gimbal, the actual yaw angle and the actual yaw angular velocity of the gimbal are fed back to the FCS, to control yawing of the aircraft. Therefore, the GCS is a main control, the FCS is a slave control, and a priority of the FCS is lower than that of the GCS. Characteristics of high-precision control and high sensitivity of the gimbal are cleverly used, vibration and a noise signal caused by the FCS during yaw control of the aircraft are avoided, thereby resolving aerial video freezing from the mechanism when a yaw axis is rotated at a low rotation speed.

Specifically, the embodiments of the present invention are further described below with reference to the accompanying drawings.

### Embodiment 1

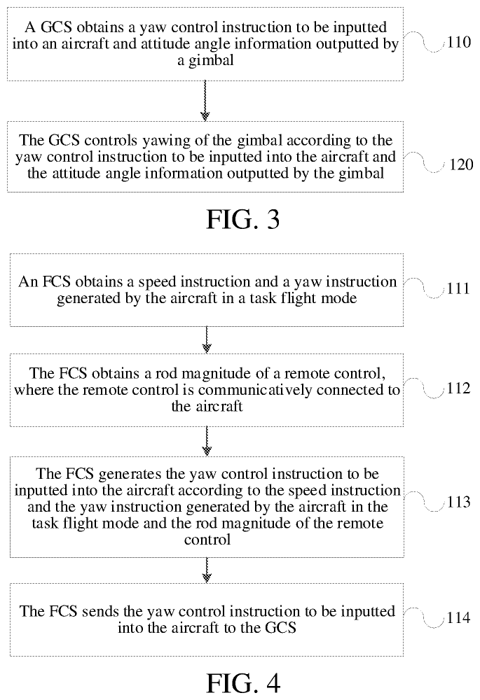

An embodiment of the present invention provides an aircraft control method. FIG. 3 is a schematic flowchart of an aircraft control method according to an embodiment of the present invention. The aircraft control method is applicable to an aircraft, to control yawing of the aircraft and improve the stability of aerial photography of the aircraft. The aircraft includes an FCS configured to control the aircraft and a GCS configured to control a gimbal, to implement high-precision photographing. The aircraft may be various types of aircrafts, for example, the aircraft 10 in FIG. 1 and FIG. 2.

Referring to FIG. 3, the aircraft control method includes, but is not limited to the following steps.

Step 110. The GCS obtains a yaw control instruction to be inputted into the aircraft and attitude angle information outputted by the gimbal.

The yaw control instruction is a yaw control instruction generated by the FCS performing instruction fusion according to a yaw instruction and a speed instruction generated by the aircraft in a current task flight mode in combination with a rod magnitude of a remote control.

The attitude angle information includes an attitude angle and an attitude angular velocity, and the attitude angle information outputted by the gimbal includes an attitude angle and an attitude angular velocity of the gimbal. The attitude angle, that is, a Euler angle, is determined according to a relative position between a body coordinate system of the aircraft and a geographic coordinate system, and three Euler angles of a yaw angle, a pitch angle, and a roll angle are respectively used for representing the attitude angle. The attitude angle represents a current angle and a current attitude of the gimbal in the air, and the attitude angular velocity represents an attitude angle change rate when the gimbal performs attitude change in the air in a current flight task. Specifically, the attitude angle information of the gimbal may be measured by using a six-axis sensor, that is, a three-axis gyroscope and a three-axis sensor, disposed on the gimbal.

Step 120. The GCS controls yawing of the gimbal according to the yaw control instruction to be inputted into the aircraft and the attitude angle information outputted by the gimbal.

The GCS is a photographing auxiliary system and is configured to improve an aerial video. High-frequency vibration of the body is usually isolated by using a vibration isolation system, and the control precision of the GCS is far higher than the control precision of the FCS. The GCS is configured to specifically control a yaw direction and speed of the gimbal of the aircraft. A motor should be disposed inside the GCS. The GCS can obtain the yaw control instruction and execute the yaw control instruction and can further drive the gimbal of the aircraft, so that the gimbal can yaw according to yaw information carried by the yaw control instruction. The GCS is specifically a control system that can convert the yaw control instruction to a corresponding pulse signal to control yawing of the gimbal.

In this embodiment of the present invention, the GCS is a main control, the FCS is a slave control, and a priority of the FCS is lower than that of the GCS. The GCS controls the yawing of the gimbal according to the yaw control instruction outputted by the FCS and the attitude angle information outputted by the gimbal.

When the aircraft control method provided by the present invention is performed, after obtaining the yaw control instruction and the attitude angle information outputted by the gimbal, the GCS executes the yaw control instruction, so that the gimbal yaws according to the yaw control instruction. Further, aerial photography may be further performed.

The embodiments of the present invention disclose an aircraft control method. The aircraft control method is applicable to the aircraft, and the aircraft includes an FCS configured to control the aircraft and a GCS configured to control a gimbal. The GCS can obtain a yaw control instruction to be inputted into the aircraft and attitude angle information outputted by the gimbal and then control yawing of the gimbal according to the yaw control instruction to be inputted into the aircraft and the attitude angle information outputted by the gimbal, so as to implement high-precision control of aerial photography of the aircraft, thereby ensuring high quality of an aerial video and resolving video freezing during aerial photography at a low rotation speed.

In some embodiments, FIG. 4 is a sub-flowchart of step 110 in the method shown in FIG. 3. Step 110 specifically includes the following steps.

Step 111. The FCS obtains a speed instruction and a yaw instruction generated by the aircraft in a task flight mode.

The task flight mode is a working mode of a flight task performed by the aircraft currently. Specifically, when the aircraft needs to fly to a target position, the aircraft generates a flight route from a current position to the target position and generates a corresponding flight task, and the aircraft enters a task flight mode of the flight task. When performing the flight task, the FCS generates a corresponding speed instruction and a corresponding yaw instruction, to drive the aircraft to fly to the target position.

The speed instruction is a speed instruction executed by the aircraft in a current task flight mode, and the speed instruction is used for controlling the aircraft to fly at a current flying speed. The yaw instruction is a yaw instruction executed by the aircraft in the current task flight mode, and the yaw instruction is used for controlling the aircraft to fly in a current yaw angle and at a current yaw angular velocity.

In this embodiment of the present invention, the FCS is the basic premise to ensure the stable flight of the aircraft. The FCS is configured to specifically control a flying speed and direction of the aircraft. At least two motors should be disposed inside the FCS, and the at least two motors can respectively obtain the speed instruction or the yaw instruction in the current task flight mode and execute the speed instruction or the yaw instruction. In addition, the at least two motors can further drive the power apparatuses of the aircraft, so that the power apparatuses fly according to flight information carried by the speed instruction and the yaw instruction. The FCS is specifically a control system that can convert the speed instruction and the yaw instruction to corresponding pulse signals to control the aircraft to perform a current flight task. The FCS may execute the speed instruction and the yaw instruction by using the motors, to control yawing of the aircraft.

Step 112. The FCS obtains a rod magnitude of a remote control, where the remote control is communicatively connected to the aircraft.

In this embodiment of the present invention, the aircraft is controlled by the remote control. Therefore, the speed instruction and the yaw instruction that control the flying speed and yawing can be changed by changing a rod magnitude of the remote control. The rod magnitude of the remote control includes rod magnitudes of joysticks in four directions of a roll rod, a pitch rod, a yaw rod, and a thrust rod. The flying direction and the flying speed of the aircraft are adjusted according to the rod magnitude.

The remote control is communicatively connected to the aircraft, to send the rod magnitude to the aircraft. The remote control and the aircraft may be in a two-way communication, and the aircraft may send a current real-time flight state of the aircraft to the remote control. Generally, the remote control is wirelessly connected to the aircraft, so that the aircraft has a freer flight space. For example, the remote control may be connected to the aircraft by Bluetooth.

Step 113. The FCS generates the yaw control instruction to be inputted into the aircraft according to the speed instruction and the yaw instruction generated by the aircraft in the task flight mode and the rod magnitude of the remote control.

After obtaining the speed instruction and the yaw instruction in the current task flight mode and the rod magnitude of the remote control, the FCS performs fusion calculation, to obtain the yaw control instruction to be inputted into the aircraft. The FCS may read the speed instruction and the yaw instruction generated by the FCS in the current task flight mode from the FCS.

Specifically, first, when the aircraft performs a flight task, the aircraft flies at a preset speed and yaws in the current task flight mode, and the FCS of the aircraft outputs a speed instruction and a yaw instruction to the power apparatus, to drive the aircraft to fly. Alternatively, when the aircraft will perform a flight task, the FCS also outputs a speed instruction and a yaw instruction to the power apparatus, to drive the aircraft to fly.

Therefore, when the speed instruction and the yaw instruction are obtained and the remote control controls the aircraft to change a flying direction and speed, a rod magnitude of the remote control is obtained, so that a yaw control instruction that drives the aircraft to fly under the control of the remote control can be generated. Further, the yaw control instruction is inputted into the aircraft to drive yawing of the gimbal and yawing of the aircraft.

Step 114. The FCS sends the yaw control instruction to be inputted into the aircraft to the GCS.

In this embodiment of the present invention, the GCS needs to be communicatively connected to the FCS. Specifically, the GCS may be in a wired communication connection or may be in a wireless communication connection with the FCS. The GCS may be in a direct connection or may be in an indirect connection with the FCS. Further, the yaw control instruction is sent to the GCS.

For example, the GCS may be in a direct physical connection with the FCS through a bus, or wireless modules are disposed inside the GCS and the FCS, and the GCS is connected to the FCS in a specific frequency band. Alternatively, the GCS may be connected to the FCS through a single chip for data processing and transmission. Subsequently, the FCS sends the yaw control instruction to the GCS through the physical connection. Specifically, a connection manner between the GCS and the FCS may be set according to an actual requirement, and a related electronic element and circuit structure or a related communication protocol or the like may also be set according to an actual condition. This is not limited in this embodiment of the present invention.

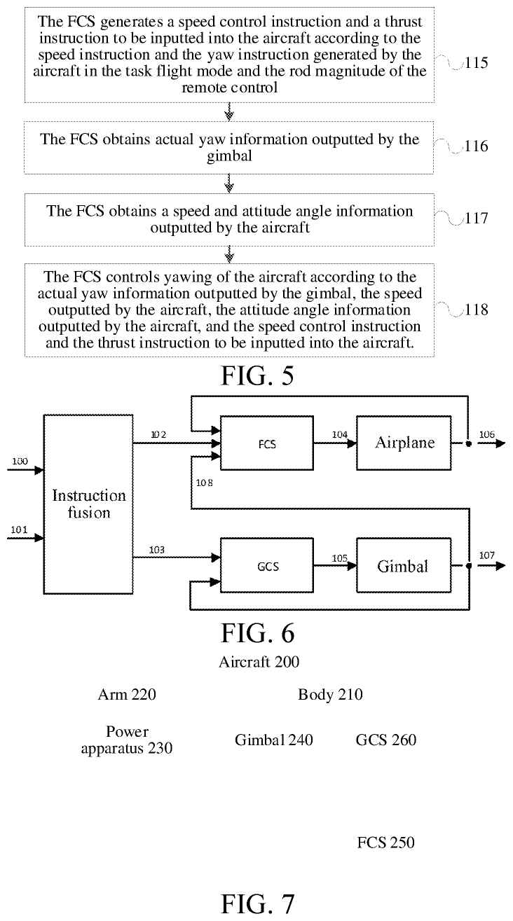

In some embodiments, FIG. 5 is another sub-flowchart of step 110 in the method shown in FIG. 3. Step 110 specifically includes the following steps.

Step 115. The FCS generates a speed control instruction and a thrust instruction to be inputted into the aircraft according to the speed instruction and the yaw instruction generated by the aircraft in the task flight mode and the rod magnitude of the remote control.

In this embodiment of the present invention, the aircraft changes a flying speed and a flying direction in the current task flight mode under the control of the remote control. Therefore, the FCS needs to generate a speed control instruction and a thrust instruction to be inputted into the aircraft according to the speed instruction and the yaw instruction generated by the aircraft in the current task flight mode and the rod magnitude of the remote control.

The speed control instruction is specifically a speed control instruction executed by a new route and corresponding flight task generated by the FCS under the control of the remote control, and the speed control instruction is used for controlling a flying speed of the aircraft. The thrust instruction is a thrust instruction generated by the FCS according to an acceleration of the aircraft in the current task flight mode and the rod magnitude of the remote control, and the thrust instruction is used for controlling a flying direction and the acceleration of the aircraft.

Step 116. The FCS obtains actual yaw information outputted by the gimbal.

The FCS obtains actual yaw information outputted by the gimbal according to the attitude angle information outputted by the gimbal. In this embodiment of the present invention, the actual yaw information outputted by the gimbal includes an actual yaw angle and an actual yaw angular velocity of the gimbal. The aircraft adjusts a yaw angle of the aircraft according to current attitude angle information of the gimbal and a yaw control instruction to be inputted into the aircraft. Subsequently, actual yaw information of the aircraft is measured by using a gyroscope. The yaw angle is one of three Euler angles representing the attitude angle and is an angle between a projection of a machine body shaft on a horizontal plane and Earth's axis.

Step 117. The FCS obtains a speed and attitude angle information outputted by the aircraft.

In this embodiment of the present invention, actual speed information outputted by the aircraft may be detected by using a speed sensor, and attitude angle information outputted by the aircraft may be measured by using a six-axis sensor, that is, a three-axis gyroscope and a three-axis sensor, disposed on the aircraft. The attitude angle, that is, a Euler angle, is respectively represented by using three Euler angles of a yaw angle, a pitch angle, and a roll angle.

In this embodiment of the present invention, the attitude angle information outputted by the aircraft includes an attitude angle and an attitude angular velocity outputted by the aircraft. The aircraft adjusts a yaw angle and a yaw angular velocity of the aircraft according to the speed control instruction to be inputted into the aircraft, the current actual yaw information of the gimbal detected by the six-axis sensor disposed on the gimbal, and the speed information and the attitude angle information outputted by the aircraft currently, and controls yawing of the aircraft.

Step 118. The FCS controls yawing of the aircraft according to the actual yaw information outputted by the gimbal, the speed outputted by the aircraft, the attitude angle information outputted by the aircraft, and the speed control instruction and the thrust instruction to be inputted into the aircraft.

In this embodiment of the present invention, the attitude angle information outputted by the aircraft includes an actual attitude angle and an actual attitude angular velocity outputted by the aircraft. The FCS obtains a current actual yaw condition of the gimbal according to the actual yaw information outputted by the gimbal and then obtains a current actual yaw condition of the aircraft according to the speed and the attitude angle information outputted by the aircraft. The FCS obtains, through calculation according to the current actual yaw conditions of the gimbal and the aircraft and the rod magnitude inputted by the remote control, a final speed control instruction and thrust instruction used for being inputted into the aircraft and controlling the yawing of the aircraft. Finally, the motor in the FCS converts the speed control instruction and the thrust instruction to corresponding pulse signals, to drive the aircraft to fly, so as to control yawing of the aircraft.

FIG. 6 is a principle diagram of an aircraft control method according to an embodiment of the present invention. Specifically, specific execution processes of the aircraft control method according to the embodiments of the present invention are described according to the principle diagram.

In FIG. 6, numbers 100 to 108 are instructions or data information that need to be transmitted and are involved in controlling the aircraft to perform steps 110 and 120, steps 111 to 114, and steps 115 to 118. An FCS in the figure is the FCS, and a motor for driving a mechanical device is disposed in the FCS. A GCS in the figure is the GCS, and a motor for driving a mechanical device is disposed in the GCS. Instruction fusion in the figure refers to that an FCS in an aircraft calculates and analyzes an initially obtained instruction. An airplane in the figure is an apparatus that controls a flying speed and direction in the aircraft, for example, a power apparatus, and the airplane is communicatively connected to the FCS. A gimbal in the figure is a device for assisting in photographing on the aircraft, and the gimbal is communicatively connected to the GCS.

Specifically, 100 is a speed instruction, [v_{xc_missino}, v_{yc_mission}, v_{zc_mission}], a yaw angle instruction ω_{c_mission}, and a yaw angular velocity \dot{ψ}_{c_mission} instruction generated when the airplane performs intelligent flight. 101 is a rod magnitude [R, P, Y, T] (a roll rod, a pitch rod, a yaw rod, and a thrust rod) of a remote control. 102 is a finally combined speed instruction [v_{xc}, v_{yc}, v_{zc}], and thrust instruction T 103 is a finally combined yaw angle instruction ψ_{c} and yaw angular velocity instruction ψ̅_{c}. 104 is a pulse-width modulation (PWM) signal of a motor of the airplane. 105 is a PWM signal of a gimbal motor. 106 is an actual speed [vₓ, v_{y}, v_{z}], an actual attitude angle [ϕ, θ, ψ], and an actual angular velocity [ωₓ, ω_{y}, ω_{z}] of the airplane. 107 is an actual attitude angle [ϕ_{g}, θ_{g}, ψ_{g}] and an actual angular velocity [\dot{ϕ}_{g}, \dot{θ}_{g}, \dot{ψ}_{g}] of the gimbal. 108 is an actual yaw angle ψ_{g} and an actual yaw angular velocity \dot{ψ}_{g} of the gimbal.

Generally, there is an error in an attitude control of the FCS, and the error is set to be:

$$\{ \begin{matrix}{e}_{ϕ} = {ϕ}_{c} - ϕ \\ {e}_{θ} = {θ}_{c} - θ \\ {e}_{p} = {\hat{ϕ}}_{c} - \dot{ϕ} \\ {e}_{q} = {\hat{θ}}_{c} - \dot{θ} \\ {e}_{r} = {\dot{ψ}}_{c} - \dot{ψ}\end{matrix}$$

The gimbal has low sensitivity to e_{ϕ} [symbol] e_{θ} [symbol] eₚ and e_{q} In other words, the gimbal is not significantly affected by e_{ϕ} [symbol] e_{θ} [symbol] eₚ and e_{q}, but eᵣ has relatively large impact on the gimbal. Generally, an order of magnitude of eᵣ is °/s, and the control precision of the gimbal is usually at 10⁻²°/s. Therefore, the control precision of the FCS is far lower than the control precision of the gimbal. In a conventional gimbal control, due to separated control of the GCS and the FCS, the control error eᵣ of the FCS is not considered, and the gimbal follows ψ of the airplane. Although the response process is a first-order smooth, in terms of angular velocity, the FCS will bring a relatively large jitter or error to the GCS or a yaw axis of the gimbal with an order of magnitude of 1-10°/s. The coupling between the yaw axis and a yaw axis of the airplane is very serious, and the gimbal is greatly affected by the yaw axis of the airplane, easily resulting in aerial video freezing especially at a low rotation speed of the yaw axis.

In a conventional aircraft control, generally, the instruction 102 and the instruction 103 are directly sent to the FCS and the GCS respectively at the same time, and the FCS and the GCS respectively control the airplane and the gimbal to adjust attitudes. Alternatively, the FCS first controls the airplane to adjust an attitude, and sends attitude information obtained after the airplane is adjusted to the GCS, and then the GCS performs stable control on the gimbal. According to such two conventional manners of adjusting and stabilizing the attitude of the aircraft, the precision of the FCS is limited, and a yaw angle and a yaw angular velocity during flight are not smooth, resulting in serious aerial video freezing when a yaw axis is rotated at a low rotation speed.

However, in this embodiment of the present invention, still referring to FIG. 6, specific working processes of performing instructions 100 to 108 and a working principle thereof are that: during flight of the aircraft, an intelligent flight adjustment program is disposed inside the aircraft. Therefore, when the aircraft is performing intelligent flight, there is a speed instruction 100, and when performing intelligent flight, the aircraft further receives rod magnitude information 101 for controlling a remote control. The aircraft performs calculation and analysis and finally combines a speed control instruction 102 and a yaw control instruction 103 by instruction fusion. In addition, the finally combined speed control instruction 102 is sent to the FCS, and the finally combined yaw control instruction 103 is sent to the GCS. Subsequently, the GCS generates the PWM signal 105 of the gimbal motor according to the instruction 103, and the gimbal adjusts a flight state after obtaining the signal 105. Actual attitude information 107 of the gimbal is then fed back to the FCS. Actual yaw information 108 of the gimbal in the actual attitude information 107 is further sent to the FCS. The FCS generates the PWM signal 104 of the airplane motor according to the actual yaw information 108 and the obtained speed control instruction 102, and the airplane adjusts a flight state after obtaining the signal 104. Specifically, the airplane first adjusts a yaw angle and a yaw angular velocity to cause the yaw angle and the yaw angular velocity to keep consistent with a yaw angle and a yaw angular velocity of the gimbal, and further adjusts a flight state of the aircraft according to the obtained speed control instruction 102.

In this embodiment of the present invention, the yaw control instruction 103 (including a yaw angle and a yaw angular velocity) generated after the instruction fusion is directly sent to the GCS. Different from a conventional method for first sending to the FCS, in this embodiment of the present invention, the yaw control instruction 103 executed by the gimbal is not polluted by noise of the airplane, and a change curve of yaw control instruction 103 is smooth. The control precision of the GCS is far higher than the control precision of the FCS. Therefore, the actual yaw information 108 of the gimbal detected/obtained after the GCS executes the yaw control instruction 103 has a smaller error than the yaw control instruction 103. The airplane adjusts a yaw state of the airplane according to the actual yaw information 108, and then adjusts a flying speed and direction. Finally, an aerial video obtained after photographing is performed will be particularly stable without video freezing and have strong wind resistance. In this embodiment of the present invention, the GCS is a main control, the FCS is a slave control, and a priority of the FCS is lower than that of the GCS. In the aircraft control method of the present invention, characteristics of high-precision control and high sensitivity of the gimbal are cleverly used, vibration and a noise signal caused by the FCS during yaw control of the aircraft are avoided, thereby resolving aerial photography video freezing from the mechanism when a yaw axis is rotated at a low rotation speed.

In addition, in this embodiment of the present invention, a feedback loop from the FCS to the GCS may be further added. Yaw information of an airplane is transferred to the GCS, and the GCS performs tracking compensation by using a differential operation and according to the yaw information of the airplane, so that a yaw state of the FCS can be further monitored. In this embodiment of the present invention, the actual yaw information 108 of the gimbal may include only actual yaw angle information or actual yaw angular velocity information of the gimbal. In some other embodiments, the setting may not be limited in this embodiment of the present invention.

An embodiment of the present invention further provides three verification methods for verifying whether the aircraft control method provided by the present invention is used.

First method: After an airplane is started, completion of calibration of a gimbal is waited; then the airplane is unlocked, and a motor enters a idle speed state; and if a throttle rod is not pushed, the gimbal will swing with a yaw rod. It indicates that the aircraft performs the aircraft control method according to the embodiments of the present invention and can obtain a stable photographed image.

Second method: When the first method is invalid, a power apparatus of the airplane is removed, and after the airplane is started, completion of calibration of the gimbal is waited; then the airplane is unlocked, and the motor enters the idle speed state; and the throttle rod is pushed, and the airplane is manually picked up to hang the airplane in the air. In this case, the gimbal will swing with the yaw rod. It indicates that the aircraft performs the aircraft control method according to the embodiments of the present invention and can obtain a stable photographed image.

Third method: When the airplane hover normally, the yaw rod or a program is opened, and an expected value of a yaw rotation speed is controlled to be less than 2°/s, a photographed video still does not freeze. It indicates that the aircraft performs the aircraft control method according to the embodiments of the present invention and can obtain a stable photographed image.

### Embodiment 2

An embodiment of the present invention further provides an aircraft. FIG. 7 is a structural block diagram of an aircraft 200 according to an embodiment of the present invention. The aircraft 200 includes a body 210, an arm 220, a power apparatus 230, a gimbal 240, an FCS 250, and a GCS 260. The arm 220 is connected to the body 210. The power apparatus 230 is disposed on the arm 220 and is configured to provide power for the aircraft 200 to fly. The gimbal 240 is disposed on the body 210. The FCS 250 is disposed on the body 210 and the GCS 260 is configured to control the gimbal 240 and is communicatively connected to the FCS 250.

The GCS 260 is configured to obtain a yaw control instruction to be inputted into the aircraft 200 and attitude angle information outputted by the gimbal 240; and control yawing of the gimbal 240 according to the yaw control instruction to be inputted into the aircraft 200 and the attitude angle information outputted by the gimbal 240.

In some embodiments, the FCS 250 is configured to obtain a speed instruction and a yaw instruction generated by the aircraft 200 in a task flight mode; obtain a rod magnitude of a remote control, where the remote control is communicatively connected to the aircraft 200; generate the yaw control instruction to be inputted into the aircraft 200 according to the speed instruction and the yaw instruction generated by the aircraft 200 in the task flight mode and the rod magnitude of the remote control; and send the yaw control instruction to be inputted into the aircraft 200 to the GCS 260.

In some embodiments, the FCS 250 is further configured to generate a speed control instruction and a thrust instruction to be inputted into the aircraft 200 according to the speed instruction and the yaw instruction generated by the aircraft 200 in the task flight mode and the rod magnitude of the remote control.

In some embodiments, the FCS 250 is further configured to obtain actual yaw information outputted by the gimbal 240; obtain a speed and attitude angle information outputted by the aircraft 200; and control yawing of the aircraft 200 according to the actual yaw information outputted by the gimbal 240, the speed outputted by the aircraft 200, the attitude angle information outputted by the aircraft 200, and the speed control instruction and the thrust instruction to be inputted into the aircraft 200.

In some embodiments, the FCS 250 is further configured to obtain actual yaw information outputted by the gimbal 240 according to the attitude angle information outputted by the gimbal 240.

In some embodiments, the actual yaw information outputted by the gimbal 240 includes an actual yaw angle and an actual yaw angular velocity of the gimbal 240.

In some embodiments, the attitude angle information outputted by the aircraft 200 includes an actual attitude angle and an actual attitude angular velocity outputted by the aircraft 200.

In some embodiments, the attitude angle information outputted by the gimbal 240 includes an attitude angle and an attitude angular velocity of the gimbal 240.

It should be further noted that in this embodiment of the present invention, the aircraft 200 may perform any method embodiment, that is, the aircraft control method provided in Embodiment 1, and have the corresponding functional modules for performing the method and beneficial effects thereof. For technical details not described in detail in the embodiment of the aircraft 200, reference may be made to the aircraft control method provided in the method embodiments, and details are not described again herein.

An embodiment of the present invention provides a computer program product, including a computer program stored in a non-volatile computer-readable storage medium, the computer program including program instructions, the program instructions, when executed by a computer, causing the computer to perform the foregoing aircraft control method. For example, the described steps 110 and 120, steps 111 to 114, and steps 115 to 118 of the method in FIG. 3 to FIG. 5 are performed, and the functions of the modules 210 to 250 in FIG. 7 are implemented.

An embodiment of the present invention provides a non-volatile computer-readable storage medium, storing computer-executable instructions, the computer-executable instructions being used to cause a computer to perform the foregoing aircraft control method. For example, the described steps 110 and 120, steps 111 to 114, and steps 115 to 118 of the method in FIG. 3 to FIG. 7 are performed, and the functions of the modules 210 to 250 in FIG. 7 are implemented.

Embodiments of the present invention disclose an aircraft control method and an aircraft. The aircraft control method is applicable to the aircraft, and the aircraft includes an FCS configured to control the aircraft and a GCS configured to control a gimbal. The GCS can obtain a yaw control instruction to be inputted into the aircraft and attitude angle information outputted by the gimbal and then control yawing of the gimbal according to the yaw control instruction to be inputted into the aircraft and the attitude angle information outputted by the gimbal. In this embodiment of the present invention, a control permission of the GCS is higher than that of the FCS, and the FCS controls yawing of the aircraft according to actual yaw information outputted by the GCS, so as to implement high-precision control of aerial photography of the aircraft, thereby ensuring high quality of an aerial photography video and resolving video freezing during aerial photography at a low rotation speed.

It should be noted that, the described apparatus embodiment is merely an example. The modules described as separate parts may or may not be physically separate, and parts displayed as modules may or may not be physical modules, may be located in one position, or may be distributed on a plurality of network modules. Some or all of the modules may be selected according to actual requirements to implement the objectives of the solutions of the embodiments.

Through the description of the foregoing embodiments, a person of ordinary skill in the art may clearly understand that the embodiments may be implemented by software in combination with a universal hardware platform, and may certainly be implemented by hardware. A person of ordinary skill in the art may understand that all or some of the processes of the methods in the embodiments may be implemented by a computer program instructing relevant hardware. The program may be stored in a computer-readable storage medium. During execution of the program, the processes of the method embodiments may be performed. The foregoing storage medium may be a magnetic disk, an optical disc, a read-only memory (ROM), a random access memory (RAM), or the like.

Finally, it should be noted that the foregoing embodiments are merely used for describing the technical solutions of the present invention, but are not intended to limit the present invention Under the ideas of the present invention, the technical features in the foregoing embodiments or different embodiments may also be combined, the steps may be performed in any order, and many other changes of different aspects of the present invention also exists as described above, and these changes are not provided in detail for simplicity. It should be understood by a person of ordinary skill in the art that although the present invention has been described in detail with reference to the foregoing embodiments, modifications can be made to the technical solutions described in the foregoing embodiments, or equivalent replacements can be made to some technical features in the technical solutions; and these modifications or replacements will not cause the essence of corresponding technical solutions to depart from the scope of the technical solutions in the embodiments of the present invention.

What is claimed is:

1. An aircraft control method, applicable to an aircraft, wherein the aircraft comprises a flight control system configured to control the aircraft and a gimbal control system configured to control a gimbal, and the method comprises:
obtaining, by the gimbal control system, a yaw control instruction to be inputted into the aircraft and attitude angle information outputted by the gimbal; and
controlling, by the gimbal control system, yawing of the gimbal according to the yaw control instruction to be inputted into the aircraft and the attitude angle information outputted by the gimbal.

2. The method according to claim 1, wherein the obtaining, by the gimbal control system, a yaw control instruction to be inputted into the aircraft and attitude angle information outputted by the gimbal comprises:
obtaining, by the flight control system, a speed instruction and a yaw instruction generated by the aircraft in a task flight mode;
obtaining, by the flight control system, a rod magnitude of a remote control, wherein the remote control is communicatively connected to the aircraft;
generating, by the flight control system, the yaw control instruction to be inputted into the aircraft according to the speed instruction and the yaw instruction generated by the aircraft in the task flight mode and the rod magnitude of the remote control; and
sending, by the flight control system, the yaw control instruction to be inputted into the aircraft to the gimbal control system.

3. The method according to claim 2, further comprising:
generating, by the flight control system, a speed control instruction and a thrust instruction to be inputted into the aircraft according to the speed instruction and the yaw instruction generated by the aircraft in the task flight mode and the rod magnitude of the remote control.

4. The method according to claim 3, further comprising:
obtaining, by the flight control system, actual yaw information outputted by the gimbal;
obtaining, by the flight control system, a speed and attitude angle information outputted by the aircraft; and
controlling, by the flight control system, yawing of the aircraft according to the actual yaw information outputted by the gimbal, the speed outputted by the aircraft, the attitude angle information outputted by the aircraft, and the speed control instruction and the thrust instruction to be inputted into the aircraft.

5. The method according to claim 4, wherein the obtaining, by the flight control system, actual yaw information outputted by the gimbal comprises:
obtaining, by the flight control system, the actual yaw information outputted by the gimbal according to the attitude angle information outputted by the gimbal.

6. The method according to claim 5, wherein the actual yaw information outputted by the gimbal comprises an actual yaw angle and an actual yaw angular velocity of the gimbal.

7. The method according to claim 4, wherein the attitude angle information outputted by the aircraft comprises an actual attitude angle and an actual attitude angular velocity outputted by the aircraft.

8. The method according to claim 1, wherein the attitude angle information outputted by the gimbal comprises an attitude angle and an attitude angular velocity of the gimbal.

9. An aircraft, comprising:
a body;
an arm, connected to the body;
a power apparatus, disposed on the arm and configured to provide power for the aircraft to fly;
a gimbal, disposed on the body;
a flight control system, disposed on the body; and
a gimbal control system, configured to control the gimbal and communicatively connected to the flight control system, wherein
the gimbal control system is configured to:
obtain a yaw control instruction to be inputted into the aircraft and attitude angle information outputted by the gimbal; and
control yawing of the gimbal according to the yaw control instruction to be inputted into the aircraft and the attitude angle information outputted by the gimbal.

10. The aircraft according to claim 9, wherein the flight control system is configured to:
obtain a speed instruction and a yaw instruction generated by the aircraft in a task flight mode;
obtain a rod magnitude of a remote control, wherein the remote control is communicatively connected to the aircraft;
generate the yaw control instruction to be inputted into the aircraft according to the speed instruction and the yaw instruction generated by the aircraft in the task flight mode and the rod magnitude of the remote control; and
send the yaw control instruction to be inputted into the aircraft to the gimbal control system.

11. The aircraft according to claim 10, wherein the flight control system is further configured to:
generate a speed control instruction and a thrust instruction to be inputted into the aircraft according to the speed instruction and the yaw instruction generated by the aircraft in the task flight mode and the rod magnitude of the remote control.

12. The aircraft according to claim 11, wherein the flight control system is further configured to:
obtain actual yaw information outputted by the gimbal;
obtain a speed and attitude angle information outputted by the aircraft; and
control yawing of the aircraft according to the actual yaw information outputted by the gimbal, the speed outputted by the aircraft, the attitude angle information outputted by the aircraft, and the speed control instruction and the thrust instruction to be inputted into the aircraft.

13. The aircraft according to claim 12, wherein the flight control system is further configured to:
obtain the actual yaw information outputted by the gimbal according to the attitude angle information outputted by the gimbal.

14. The aircraft according to claim 13, wherein the actual yaw information outputted by the gimbal comprises an actual yaw angle and an actual yaw angular velocity of the gimbal.

15. The aircraft according to claim 12, wherein the attitude angle information outputted by the aircraft comprises an actual attitude angle and an actual attitude angular velocity outputted by the aircraft.

16. The aircraft according to claim 9, wherein the attitude angle information outputted by the gimbal comprises an attitude angle and an attitude angular velocity of the gimbal.
